(19) United States
(12) Patent Application Publication
(10) Pub. No.: US 2007/0210924 A1
(43) Pub. Date: Sep. 13, 2007

(54) RFID Smart Label with Reduced Layers and Method of Production

(75) Inventors: Rocky R. Arnold, San Carlos, CA (US); Pier Giorgio Antoniucci, Los Gatos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Wavezero, Inc., Sunnyvale, CA (US)

(21) Appl. No.: 11/682,437

(22) Filed: Mar. 6, 2007

Related U.S. Application Data
(60) Provisional application No. 60/852,373, filed on Oct. 16, 2006.
(60) Provisional application No. 60/781,114, filed on Mar. 10, 2006.

(51) Int. Cl. G08B 13/14

(52) U.S. Cl. 340/572.8

(57) ABSTRACT

An RFID smart label includes a plurality of layers, wherein one of the plurality of layers is an RFID inlay with a depression/recession region for holding the RFID chip/strap so that it does not extend above the surface of the antenna. The depressed/recessed region can have substantially the same depth as the thickness of the RFID chip/strap. High speed printing processes are then used to economically print labels on the RFID inlays having the RFID chip/strap embedded because there are no bumps to impede the printing process. A method for reliably and economically manufacturing a radiofrequency identification (RFID) antenna includes impressing a pattern on a surface of a substrate to make a first portion of the substrate having a positive image of the RFID antenna and a second portion of the substrate having a negative image of the RFID antenna, applying a release agent on the second portion of the substrate having a negative image of the RFID antenna, depositing a metallization layer over the surface of the substrate, applying a solvent over the metallization layer, and scraping the surface of the substrate causing mechanical interruption of the metallization layer. The release agent can be masking materials containing TiO₂ or oil.

### CROSS-REFERENCES TO RELATED APPLICATIONS

This application claims the benefit of U.S. Provisional Application No. 60/781,114, filed Mar. 10, 2006, and U.S. Provisional Application No. 60/852,373, filed Oct. 16, 2006, which are incorporated herein by reference in their entirety for all purposes.

### BACKGROUND OF THE INVENTION

The present invention relates generally to radio frequency identification (RFID) tags and in particular to the design and manufacture of RFID straps and inlays fabricated out of planar roll materials (paper, polymer, etc.) in a manner that causes the RFID chip/strap to be at or below the surfaces of the planar material.

RFID is an emerging technology for identifying many manners of assets including people, equipment, products etc based upon radio communications. RFID has been viewed as a replacement technology for bar codes. An RFID tag is a complete device designed to receive a radio frequency communication at a specific frequency and return a radio frequency communication containing data and information. The data and information returned by the RFID tag generally contains information describing the item to which the tag is attached. The radio frequency communication received by the RFID tag is usually a high frequency (HF) of approximately 13.56 MHz. or an ultra high frequency (UHF) of approximately 985 MHz. In the case of passive RFID tags, the tags become charged with energy when they receive the radio frequency communication.

Typical RFID tags are also designed to have an operating range ranging from 5-6 feet for HF devices and up to 15 ft. for UHF devices. Nevertheless these ranges change dramatically depending upon the design of the RFID integrated circuit (IC), the antenna, and the orientation of the tag relative to a reader that both supplies energy (in the case of passive RFID) and requests and “reads” the output of the RFID tag.

In order to help make the use of RFID tags more common, the cost of manufacturing RFID tags must be reduced. For example, the cost to manufacture RFID tags that are used for tracking commodities should be less than 1% of the cost of manufacturing the item to which the RFID tag is attached. In some special applications including pharmaceutical, medical, military, etc., RFID smart labels or tags are used instead of conventional RFID tags. RFID smart labels not only contain decorative images for customer appeal, but also contain the RFID device, bar coding information, and can contain various types of security devices. RFID smart labels or tags use seven layers, and the entire device is assembled with modern high speed equipment in a sequential operation. While the cost of assembling a modern RFID smart label is arguably small because of the economies of high speed printing and label converting devices, the cost is still more than the majority of significant users can afford. In a typical application for a market willing to pay more because of the intrinsic value secured, a typical smart label may cost from $0.20 to $1.00. Although specialized high end markets are willing to pay more for RFID smart labels, the broader and larger commercial (consumer) market for RFID smart labels is not expected to emerge until the price of an RFID smart label approaches $0.05 (or lower).

Both conventional and smart RFID tags and labels are manufactured by using relatively small planar shaped continuous patterns of metal to create antennas that are essential to the operation of RFID. These antenna patterns can be manufactured using semiconductor-like processes to form alternating layers of deposited materials that are subsequently either protected from removal with a mask or are removed with an etching solution. This approach is relatively cumbersome and too expensive for the rapidly expanding markets of RFID smart labels. One problem with making reliable inexpensive RFID antennas is determining how to create the desired pattern using a minimum number of processes to deposit metal layers on substrates made of plastic films. One highly effective method of manufacturing reliable metal layers on substrates is to use vapor deposition (or vacuum metallization). Vapor deposition (especially thermal evaporation and sputtering) are relatively low temperature processes that avoid thermal distortion of the underlying thin film (usually 2-5 mils in thickness). Properly done, single or multiple layers of one or more types of metals can be vapor deposited on film having thicknesses ranging from 1-5 microns, which, even in their micron level thicknesses, enable high technical performance of the RFID tag. Because of the relative speed of automated vacuum operations, economical production of RFID antenna can be accomplished provided efficient methods of creating a pattern are available. However, in a manufacturing environment, forming these antenna patterns is problematic.

FIG. 1 is a diagram illustrating a prior art layering scheme for fabricating RFID smart labels with seven layers. FIG. 1 includes a release agent layer 110, an adhesive layer 115, a substrate layer 120, an RFID antenna layer 125, an RFID Chip/Strap layer 130, a second adhesive layer 135, and a facestock layer 140. The facestock layer 140 is a layer (i.e. paper or polymer) that contains graphics or information that is attached to the RFID Chip/Strap layer 130 with the adhesive 135. The graphics or information is intended to be read by a user or other electronic device. The relatively high cost of manufacturing this seven layer RFID smart label is due to the requirement that the prior art RFID smart label shown in FIG. 1, requires seven layers and each layer has an associated cost.

One approach to lowering cost is to reduce the numbers of layers. However, one of several problems with reducing the number of layers is handling the “bump” produced by the RFID chip (RFIC) or the RFID chip/strap. Specifically, roll to roll processing, including printing, requires that the top/bottom surfaces of a film or substrate be virtually flat and without intervening protrusions that may interfere with the print rollers, anilox, and masks.

Therefore, what is needed, is a system and method for reliably and economically forming antenna patterns used for RFID tags that continue to have the same level of performance but are cheaper to make.

### BRIEF SUMMARY OF THE INVENTION

The present invention provides a method for reliably and economically forming antenna patterns used for RFID tags using semiconductor-like processes or simple industrialized processes to deposit single or multiple layers on thin substrates using vapor deposition techniques, which is useful for manufacturing RFID tags.

Embodiments of the present invention include RFID smart tags and labels with fewer layers and methods for economically and reliably making these RFID smart tags and labels with fewer layers then conventional RFID tags. RFID smart tags and labels include layered structures where the facestock and facestock adhesive layers shown in FIG. 1 have been removed and the RFID chip/strap is placed in a depression/recession located in the RFID antenna or substrate. The RFID chip/strap is positioned within the depression/recession region so that graphics or information normally contained on the facestock can be printed directly onto the RFID chip/strap. Methods for reliably and cost effectively making these RFID smart labels, in accordance with embodiments of the invention, include making a depression/recession in the RFID antenna and/or the substrate and positioning the RFID chip/strap in the depression/recession so that the RFID chip/strap does not protrude above the surface of the RFID antenna. By locating the RFID chip within the top/bottom boundaries of a substrate, the facestock and adhesive holding the facestock can be removed while minimizing interference between the RFID and the printing process or other processes involved with roll-to-roll processing. By enabling roll-to-roll processing and removing the facestock and facestock adhesive, the RFID smart label can be made at a lower cost.

Methods for making both conventional RFID tags and RFID smart tags and labels, in accordance with embodiments of the invention, include first impressing a pattern on a surface of a substrate to make a first portion of the substrate have a positive image of the RFID antenna and a second portion of the substrate have a negative image of the RFID antenna. Projections are then formed in the second portion of the substrate having a negative image of the RFID antenna. A release agent is then applied to the second portion of the substrate having the negative image of the RFID antenna. A metallization layer is then deposited over the surface of the substrate, a solvent is applied over the metallization layer, and the surface of the substrate is scraped causing mechanical interruption of the metallization layer. The metallization layer can be deposited using a bi-directional metallization process.

Embodiments of the present invention provide a method of positioning an RFID chip within the top/bottom boundaries of a substrate for purposes of minimizing the RFID interference with the printing process or other processes involved with roll-to-roll processing. By positioning the RFID chip within the top/bottom boundaries of a substrate, the RFID can be made at a lower cost by removing the facestock layer and the adhesive layer.

In another embodiment of the present invention, the RFIC is located within a depression/recession region of the substrate. The depression/recession region may be created by a process known in the printing industry as debossing. In one embodiment, the substrate or film is 2 to 5 mils thick and the RFIC is 20 μm (0.8 mils). Thus, the RFID constitutes about ⅓^{rd} to ¼^{th} of the thickness of the film or substrate.

In another embodiment of the present invention, the depression/recession region is created as a gradual change. For example the gradual change in the depression does not have distinct edges. Although the gradually changing depression is changeable, in one embodiment it would be 3-4 times the RFIC planar length or width.

In yet another embodiment of the present invention, the depression/recession region, which can be any shape, is filled with a supplemental adhesive and made smooth. This further anchors the RFIC and makes the surface smooth for purposes of printing and handling.

Embodiments of the present invention provide an RFID smart label, including a substrate with a depression/recession region, an RFID antenna deposited over the substrate, an RFIC located within the depression/recession region but not extending above the RFID antenna. The RFIC and the RFID antenna form a substantially flat surface for directly printing information or graphics using a roll printer, and wherein the RFID smart label contains less than seven layers. The RFID smart label can further include information or graphics that has been directly printed on the RFIC and RFID antenna. In some embodiments the substrate can be a roll or a polymer roll.

In another embodiment of the present invention, an RFID smart label, includes a release agent, an adhesive, a substrate, an RFID antenna, and an RFID chip/strap. The release agent is used as a liner for removing other layers. The adhesive is used to couple the release liner to the substrate. The adhesive has a strength that is low enough to allow the release liner to be easily removed (i.e. by peeling). The substrate has a depression/recession region for insertion of the RFID chip/strap. The RFID antenna is used for receiving or transmitting signals. The RFID chip/strap is used to process signals going or coming from the RFID antenna. The RFID chip/strap is located in the depression/recession region and does not extend above the RFID antenna so that the RFID chip/strap and the RFID antenna form a substantially flat surface for directly printing information or graphics using a roll printer. Some examples of the release agent, which is used as a release liner, are masking materials that include, TiO₂, or oil. In one embodiment the masking material is an ink containing about ⅓ Ti0₂ dispersed in other chemicals. The RFID smart label can further include information or graphics that has been directly printed on or around the RFIC and RFID antenna.

In yet another embodiment of the present invention, the RFID smart label can include a passive component so that the RFID smart label does not have internal power.

In yet another embodiment of the present invention the RFID smart label can include an active component and a power source for running the active component.

In another embodiment of the present invention, an RFID smart label includes an RFID inlay having an exterior surface and a depression/recession region located in a substrate, wherein the RFID inlay is configured to support an RFIC or RFID chip/strap in the depression/recession region to be substantially conformal with the exterior surfaces of the RFID inlay for directly printing on the exterior surfaces of the RFID inlay information or graphics using a roll printer. The RFID smart label can further include information or graphics that has been directly printed on the exterior surfaces of said RFID inlay.

In yet another embodiment of the present invention, the depression/recession region has substantially the same depth as the thickness of the RFIC or RFID chip/strap.

In yet another embodiment of the present invention, the depression/recession region is deeper than the thickness of the RFIC or RFID chip/strap.

In yet another embodiment of the present invention, the substrate thickness ranges between 2 mils and 5 mils. The RFIC or RFID chip/strap thickness is about 0.8 mils.

In yet another embodiment of the present invention, the depression/recession region has a depth ranging from between ⅓ and ¼ of the thickness of the substrate.

In yet another embodiment of the present invention, the depression/recession region is formed gradually by reducing the thickness of a substrate from a first thickness to a second thickness.

In another embodiment of the present invention, an RFID smart label includes a substrate that has a first surface and a depression/recession region in the first surface, wherein the depression/recession region includes a second surface that is substantially parallel to the first surface, a third surface connecting the first surface to the second surface, and an RFIC or RFID chip/strap positioned on the second surface. The third surface is not perpendicular to either the first surface or to the second surface.

In yet another embodiment of the present invention, the third surface has a length and width that is substantially longer than the length and the width of the second surface.

In yet another embodiment of the present invention, the length and width of the third surface is 3 to 4 times larger than the length and width of the second surface.

In yet another embodiment of the present invention, the second surface has a length and a width sufficiently large to hold the RFIC or RFID chip/strap.

In yet another embodiment of the present invention, the length and width of the third surface is 3 to 4 times larger than the length and width of the RFIC or RFID chip/strap.

In yet another embodiment of the present invention, the depression/recession region has substantially the same depth as the thickness of the RFIC or RFID chip/strap

Embodiments of the present invention also include methods of manufacturing an RFID smart label comprising, first providing a substrate to support an RFIC or RFID chip/strap, making a depression in the substrate for positioning the RFIC or RFID chip/strap in the depression, and positioning the RFIC or RFID chip/strap in the depression so that the RFIC or RFID chip/strap is substantially conformal with an exterior surfaces of the substrate. The RFIC or the RFID chip/strap and the exterior surface of the substrate form a substantially flat surface for directly printing information or graphics using a roll printer.

In yet another embodiment of the present invention, the method further includes printing information or graphics directly on the RFIC or RFID chip/strap and the exterior surface of the substrate.

In yet another embodiment of the present invention, the depression is done with debossing. The debossing can include indenting approximately 15% to 35% of the surface of the substrate.

In yet another embodiment of the present invention, the depression is done with thermoforming.

In another embodiment of the present invention, a method for manufacturing a radiofrequency identification (RFID) antenna, includes impressing a pattern on a surface of a substrate to make a first portion of the substrate having a positive image of the RFID antenna and a second portion of the substrate having a negative image of the RFID antenna, applying a release agent on the second portion of the substrate having a negative image of the RFID antenna, depositing a metallization layer over the surface of the substrate, applying a solvent over the metallization layer, and scraping the surface of the substrate causing mechanical interruption of the metallization layer. In some embodiments, scraping the substrate can include a small force such as simply rinsing the substrate. The method can further include forming projections in the second portion of the substrate having a negative image of the RFID antenna wherein the projections are higher than the second portion of the substrate. The metallization layer can be deposited using a bi-directional metallization process.

In yet another embodiment of the present invention, the projections formed in the second portion of the substrate are bumps that protrude above the second portion of the substrate.

In yet another embodiment of the present invention, the step of applying a release agent further includes applying a masking material containing either TiO₂, or oil.

In yet another embodiment of the present invention, the step of depositing a metallization layer further comprises vacuum depositing a metallization layer.

In yet another embodiment of the present invention, a facestock is applied using a roll printing process.

In yet another embodiment of the present invention, the metallization layer is deposited using a bi-directional metallization. Bi-directional metallization can also be done with vacuum deposition processes.

### BRIEF DESCRIPTION OF THE DRAWINGS

FIG. 1 is a diagram illustrating a prior art layering scheme for fabricating RFID smart labels.

FIG. 2 is a diagram illustrating a layering scheme for fabricating RFID smart labels with fewer components, in accordance with one embodiment of the invention.

FIG. 3 is a block diagram illustrating a substantially conformal RFID, in accordance with another embodiment of the invention.

FIG. 4 is a block diagram illustrating a substantially conformal RFID with a gradually changing depression/recession region, in accordance with another embodiment of the invention.

FIG. 5 is a flowchart showing the steps used to manufacture a radiofrequency identification (RFID) antenna using patterning processes and release agents in accordance with one embodiment of the present invention.

FIG. 6 is a flowchart showing the steps of an alternative method used to manufacture a radiofrequency identification (RFID) antenna using patterning processes and release agents in accordance with another embodiment of the present invention.

### DETAILED DESCRIPTION OF THE INVENTION

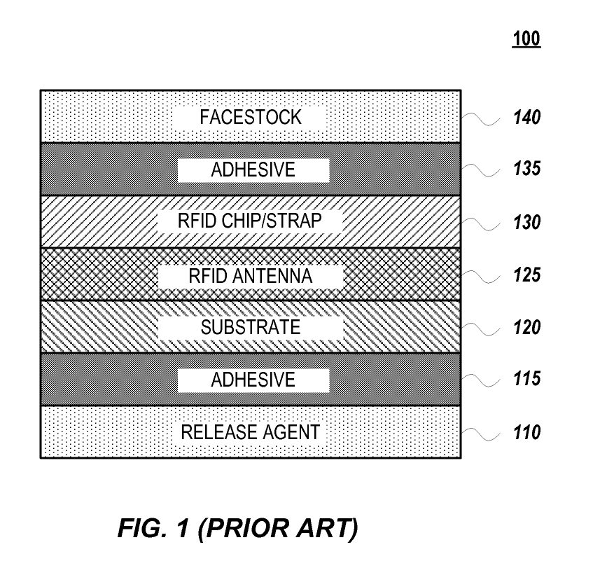

Embodiments of the present invention include RFID smart tags and labels with fewer layers that can be manufactured using roll to roll processing. Embodiments of the present invention also include methods for making RFID smart tags and labels having fewer layers. RFID smart tags and labels include layered structures where the facestock and facestock adhesive layers illustrated in FIG. 1 have been removed and a depression/recession region is provided to make room for the RFIC or RFID chip/strap. The RFID chip/strap is positioned within the depression/recession region so that graphics or information normally contained on the facestock can be printed directly onto the RFID chip/strap. Methods for making both conventional RFID tags and RFID smart tags and labels, in accordance with embodiments of the invention, include first impressing a pattern on a surface of a substrate to make a first portion of the substrate have a positive image of the RFID antenna and a second portion of the substrate have a negative image of the RFID antenna. Projections are then formed in the second portion of the substrate having a negative image of the RFID antenna and a release agent is applied to the second portion of the substrate having the negative image of the RFID antenna. A metallization layer is then deposited over the surface of the substrate, a solvent is applied over the metallization layer, and the surface of the substrate is scraped causing mechanical interruption of the metallization layer. The scraping process can include applying an aggressive force or a gentle force such as simply rinsing the substrate. The metallization layer can be deposited using a bi-directional metallization process.

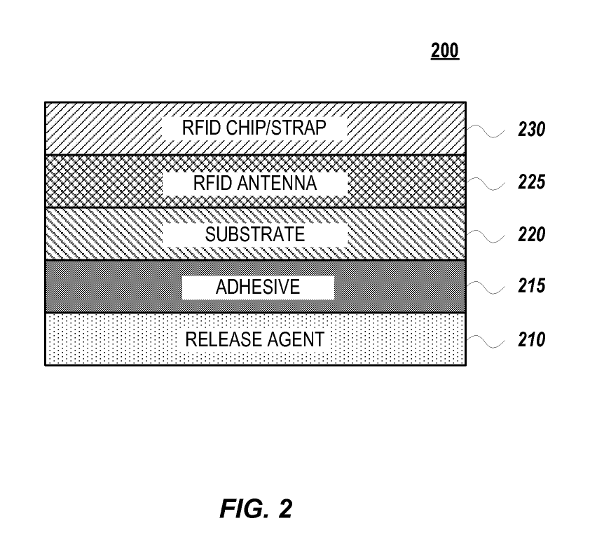

FIG. 2 illustrates the layered structure of an RFID smart label 200, including a release agent layer 210, an adhesive layer 215, a substrate layer 220, an RFID antenna layer 225, and an RFIC or RFID Chip/Strap layer 230. Although FIG. 2 appears to be similar to FIG. 1, there are some differences between the two as will be discussed below with reference to the FIGS. 2-4. It is less expensive to manufacture the structure of FIG. 2 than it is to manufacture the structure of FIG. 1 because the structure of FIG. 2 does not include the facestock and adhesive layers. In addition to having less material, there is an added cost associated with manufacturing an RFID smart label with these two layers because more processes are required.

The release agent layer 210, which is deposited onto a front surface of the substrate, is used to prevent the permanent adhesion of subsequently deposited coatings such as metal layers that are vapor coated to an underlying surface (e.g., the substrate). The release agent layer 210 is used to release other layers and is referred to as a release liner. Masking materials can be used as release agent. One example of a masking material that can be used as a release agent is mixture containing TiO₂, which can be removed from a plastic film substrate by a combination of solvent (water) and mechanical action (brushing). The solvent (i.e. water) acts to loosen the underlying mask layer from the substrate and in the process of mechanical agitation (either from water pressure or a brush) carries away the deposited layer of metal. The proposed mask works as long as the mask material is soluble in the mask solvent. Another example of the release agent is oil, which interrupts the subsequent deposition of materials. In one embodiment enough oil is deposited so that a sufficient amount of the oil remains during the deposition process. Polymer film materials are then impregnated on the surface with the oil not removed by vacuum deposition processes. The remaining oil which has already interfered with good metal adhesion dissolves in an appropriate solvent. In a preferred embodiment, a masking material is used as the release agent in the release agent layer 210. Also, in the preferred embodiment the masking material is suspended in a blend of water and other chemicals to enhance and perfect the ability of the initially liquid masking material to be printed by any number of standard processes (i.e. flexography). The release agent can be deposited by any number of means, including printing, to form an image. If oil is used as the release agent, then oil can be applied using a suitable designed roller with raised portions that have been slightly wetted with the release agent in the form of the desired negative image. The image can be the negative of the final antenna image desired. The adhesive 215 is used to attach the release agent layer to the substrate 220. The adhesive 215 is a low strength adhesive that enables the release agent layer 210 to be easily removed from the remaining assembly so that the remaining layers may be bound to the item requiring the RFID smart label.

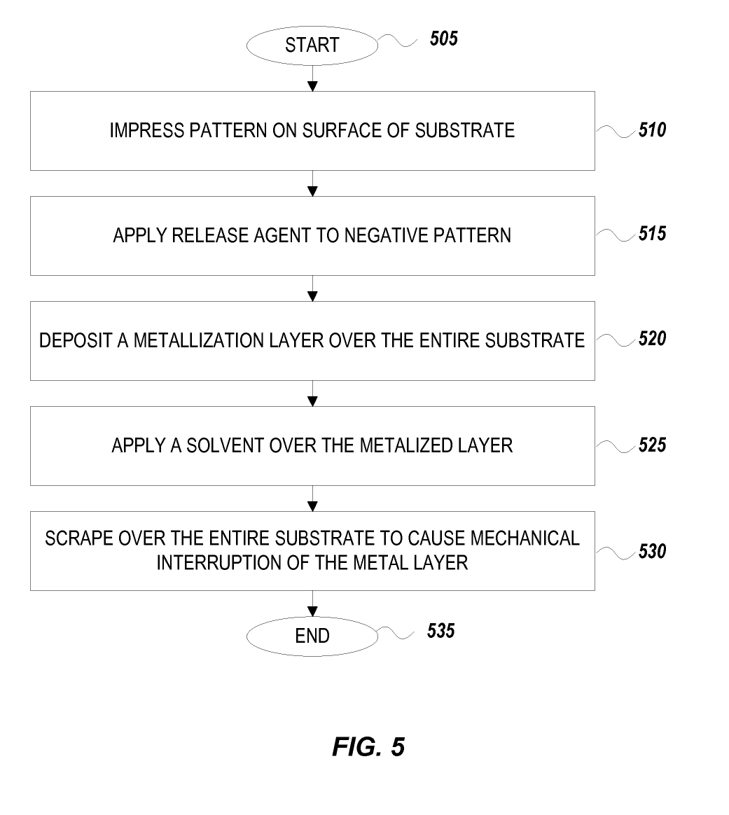

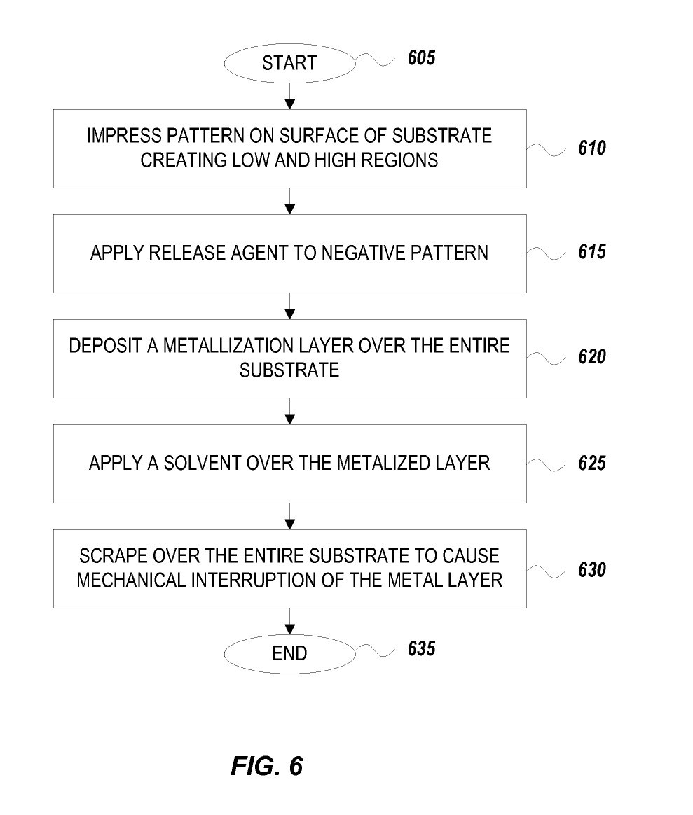

The substrate 220 is used as a surface on which the RFID antenna 225 is deposited. The substrate can be any material onto which the RFID antenna can be deposited, including paper, polymer film, etc. If an application requires a sturdy RFID then, the substrate 220 can be made out of a material which is sturdier such as metal, silicon etc. However, if the application requires a flexible RFID, the substrate 220 can be made out of a flexible material such as paper, polymer film, etc. In a preferred embodiment, flexible RFID smart labels are used and the substrate 220 is made of polymer. The RFID antenna 225 is made of a metal that is deposited onto the substrate 220 according to a pattern. The metal used for the RFID antenna 225 can be copper, aluminum, silver, gold, etc. The pattern of the antenna is chosen according to the application. Antenna patterns can include designs which feature a myriad of connected lines made of conductive silver ink. Other antenna patterns can include solid mass designs having only small areas that connect in a trace-like fashion to the RFIC. These designs are used when the thickness of the metal layer is relatively small (<5 microns). The antenna transmits/receives RF signals according to the quality (i.e. density, conductivity) of the deposited material, antenna design, and the specifics of the RFIC. The metal layer can be deposited using various metal deposition methods including vapor deposition. The metallization layer can also be deposited using a bi-directional metallization process. Although the metal layer firmly adheres to those areas of the film substrate not covered by the release agent layer 210, the metal layer does not adhere very well to those areas of the film substrate that are covered by the release agent. Moreover, the metal layer is easily removed from the areas of the substrate 220 having a release agent layer 210 by using a solvent and mechanical action. Further details of the methods used to deposit the RFID antenna 225 are described below with reference to FIG. 5 and FIG. 6. Methods used for reliable removal of the release agent without damaging the remaining metallized pattern, which makes up the antenna pattern, are also described below with reference to FIG. 5 and FIG. 6.

The RFIC or RFID chip/strap 230 is connected to the RFID antenna 225. The RFIC is used to process signals sent to and from the RFID antenna while the strap carries, holds and attaches the chip to a small piece of planar material that can be located on the RFID antenna 225. In some embodiments only the RFIC is used whereas in other embodiments the RFID chip/strap, which includes the RFIC and a strap, is used. The RFIC or RFID chip/strap 230 is placed in a recessed/depressed region located in either the substrate 220 or the RFID antenna 225 or both. By placing the RFIC or RFID chip/strap 230 in the depressed/recessed region, high speed printing can be performed on the surface of the film stack in which the RFIC or RFID chip/strap 230 is located. High speed printing on the RFIC or RFID chip/strap 230 enables the fabrication of low cost robust RFID smart labels by reducing the number of material labels. High speed printing processes can be accomplished with one or more layers depending upon the compatibility of the masking materials with the subsequent processes of metal deposition and mask removal. Without the depressed/recessed region, the RFIC or RFID chip/strap 230 would lie above the RFID antenna 225 creating a bump. This bump would interfere with the high speed printing process, which is very sensitive to aberrations in the printing surface. The prior art did not have this problem because the RFIC or RFID chip/strap 130 is covered by an adhesive layer 135 and a facestock 140, hiding any aberrations caused by the RFIC or RFID chip/strap 130. The substrate 220, RFID antenna 225 and RFIC or RFID chip/strap 230 collectively make up the RFID inlay which is the core of the RFID smart label. The RFID smart label may be either a passive label (i.e. no power of its own) or an active label (i.e. contains a power source such as a battery).

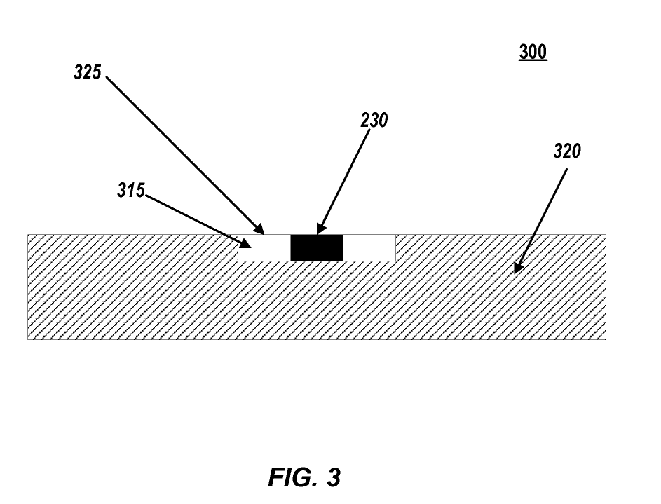

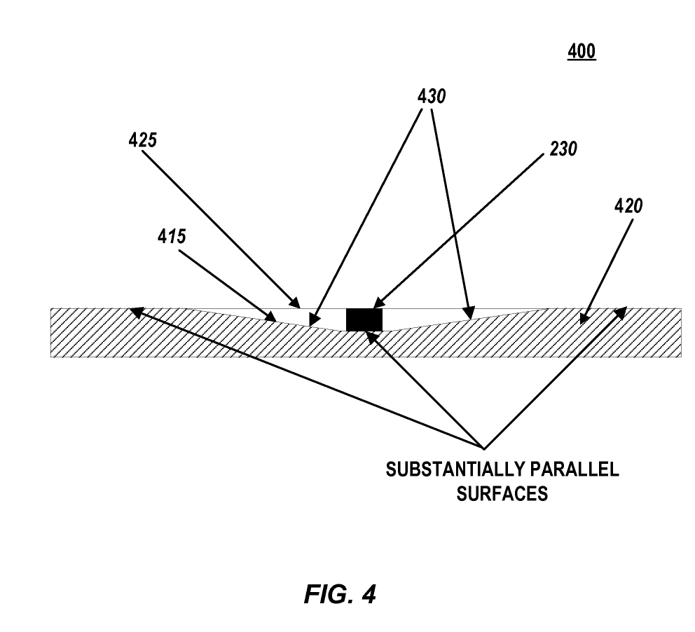

The embodiment of FIG. 2 not only reduces the number of layers used in making the RFID smart label by eliminating the facestock and facestock adhesive layers but also provides a structure wherein printing can be performed directly on the RFIC or RFID chip/strap 230 layer. Either of these advantages by themselves is enough to reduce the cost of manufacturing. That is, the reduction of two layers reduces the cost of manufacturing because fewer materials and manufacturing processes are needed and the ability to use printing technology to directly print onto the RFIC or RFID chip/strap 230 layer also reduces the cost of manufacturing. The combination of both these advantages significantly reduces the cost of manufacturing RFID smart labels. If a depressed/recessed region is not provided, then the RFIC or RFID chip/strap 230 will cause a “bump” on the surface of the inlay which is disruptive to the printing process. Because the printing process efficacy (e.g., quality of the image) is very sensitive to the surface properties of the material upon which the ink is being deposited, this bump will cause printing problems. However, by providing a depressed/recessed region there is no noticeable bump that will cause printing problems Dimensions, in terms of height, as little as tens of microns, can disrupt the process. Further details regarding the depressed/recessed regions are provided with reference to FIG. 3 and FIG. 4 below. Printing can be done using an anilox roller to disperse/distribute printing ink to a label front.

The RFID smart label 200 illustrated in FIG. 2 can be manufactured at a lower cost than the prior art RFID label illustrated in FIG. 1 because it contains fewer components and/or materials (i.e. few layers). As shown in FIG. 1, a prior art RFID label contains at least seven layers. In addition to containing the layers illustrated in FIG. 2, the RFID label shown in FIG. 1 includes a facestock which contains the image desired by the customer/user of the final product along with adhesive. Although the RFID label of FIG. 1 contains a label desired by the customer/user, a converter takes the RFID label of FIG. 1 and combines it with other layers to form a final smart label suitable for providing to a final customer who will, just before applying it to the article to be tracked, remove the release agent used as release liner thus revealing a label with a adhesive coating suitable for attachment of the label to the part. In contrast, the RFID smart label 200 of FIG. 2 can still be sent to the customers/users who can finalize it to have their own label printed on the RFID smart label 200 without the use of intermediate labels (i.e. facestock and adhesive).

FIG. 3 is an illustration showing an enlarged view 300 of the placement of the RFIC or RFID chip/strap 230 positioned within a depression/recession region 315 in either the substrate or antenna regions 320. The shape of the depression/recession region 315 may vary from a rectangular shape having sharp edges (shown) to a “gouge” in which the shape is gently depressed into the substrate or film (not shown). The depression 315 is sufficiently deep so that when the RFIC or RFID chip/strap 230 is placed in the depression 315 the top of the RFIC or RFID chip/strap 230 does not extend above the top of the substrate or film 325. This configuration ensures that the RFIC or RFID chip/strap 230 does not cause a bump that extends above the top of the substrate or film 325 and that all substrate surfaces upon which ink is to be placed are smooth to a relatively high degree. Thus, as shown in FIG. 3, this can be accomplished by positioning the RFIC or RFID chip/strap 230 within the interior confines of the external surfaces.

The configuration illustrated in FIG. 3 can be accomplished by a process called debossing wherein a roller used in the printing process is used to slightly depress a surface of the substrate to a depth that is substantially the same as the thickness of the RFIC or RFID chip/strap 230. The roller can be integrated into a printing apparatus. In one embodiment, the RFID chip/strap is approximately 10 microns to 25 microns thick. Additionally, the substrate thickness can be 3 mils (75 microns). In this embodiment, approximately 15% to 35% of the substrate is indented by debossing.

The depression can also be accomplished by a process called thermoforming. Thermoforming is similar to debossing except heat and vacuum are used to form the final shape.

Assembly of the RFIC or RFID chip/strap is accomplished by techniques known in the art. One such technique involves providing the RFIC or RFID chip/strap with a conductive Z-axis adhesive that further affixes the RFIC or RFID chip/strap to the substrate. The conductive adhesive secures the RFIC or RFID chip/strap 230 in the depressed/recessed region 315 such that the top surface of the RFID smart label 200 is flush or level with the surface into which the RFIC or RFID chip/strap is placed.

In other embodiments, where the depression is very tight or just sufficient to hold the RFIC or RFID chip/strap, there is no advantage to using additional non-conductive material (such as an adhesive) to make the entire surface flat and ready for the label printing process. In other embodiments, it may be desirable to add non-conductive adhesive to provide a completely flat surface.

The depression may lie in any orientation on the surface of the substrate or antenna. However, in some cases a particular orientation is desired because the film is rolled onto various size carrier rolls and the orientation of the depression may be perpendicular to the roll direction.

FIG. 4 is a block diagram illustrating an enlarged view of the placement of the RFIC or RFID chip/strap in a substantially conformal RFID smart label with a gradually changing depression, in accordance with another embodiment of the invention. FIG. 4 shows an illustration of the placement of an RFIC or RFID chip/strap 230 within a depression 415 in the substrate or film 420. The depression 415 is sufficiently deep so that when the RFIC or RFID chip/strap 230 is placed in the depression 415, the top of the RFIC or RFID chip/strap 420 does not extend above the top of the substrate or film 425. The shape of the depression 415 includes a tapered surface 430 which transitions from the top of the substrate or film 425 to the bottom of the depression region 415. The tapered surface 430 is a gradual change that does not include distinct edges as depicted in FIG. 3. The tapered surface 430 can vary from application to application. In one application the length of the tapered surface 430 can be 3-4 times the RFIC or RFID chip/strap 230 planar length or width. In other embodiments the tapered surface 430 can be 1-2 times the length of the RFIC or RFID chip/strap 230 planar length or width.

FIG. 5 is a flowchart showing the steps used to manufacture an RFID smart label 200 using patterning processes and release agents in accordance with one embodiment of the present invention. The process begins at step 505 where a substrate is introduced. In step 510, the desired antenna pattern is first impressed into the top of the substrate using a metal tool of appropriate dimensions. Additionally, the surfaces of the substrate to be metallized with a pattern can be slightly depresses with an impress tool to make room for the placement of an RFIC or RFID chip/strap. The impress tool can be warm. Subsequently, in step 515 the release agent is applied in the desired pattern (corresponding to the impressed area). The release agent, for example can be a masking material. The masking material is an ink solution that contains about ⅓ Ti0₂ as well as other chemicals. The mechanically impressed image can be taken as a “positive” image of the antenna pattern whereas the release agent appears as a negative image of the antenna pattern. Next in step 520, a metal layer is vapor deposited over the impressed substrate covering the entire area including the release agent. In step 525 a solvent (e.g. water) is applied over the entire metal layer. In some cases, activating the release agent by using a solvent may not be possible as the entire layer of release agent is also covered by the metal deposited layer. In order to get around this problem, the entire surface is scraped in step 530 causing mechanical interruption of the metal layer. By scraping over the entire surface to cause a mechanical interruption of the metal layer, the layer containing the release agent is exposed to the solvent which in turn undermines the metal layer causing the negative pattern to be removed. The scraping process may be enhanced by scraping intermittent areas (e.g., scratching). Increasing the number of many access points to the underlying mask increases the likelihood that the solvent will access the release layer. In one embodiment, scraping is done by contacting the top surface of the structure with brushes of various kinds (i.e. brushes with varying thickness of bristles, brushes with varying flexibility of bristles, etc.) As the impressed area is beneath the mechanical action, it remains undamaged and untouched. This method achieves the desired goal and the process ends in step 535.

In another embodiment, the surfaces of the substrate to be metallized with a pattern are slightly depresses with an impress tool to make a depression/recession region for the insertion an RFIC or RFID chip/strap. The impress tool can be warm. In one embodiment the temperature of the impress tool is set to be slightly above room temperature. The temperature of the impress tool can vary and can be optimized depending on the application. A patterned layer of masking material is then applied to the impressed surface followed by metallization. The elevated regions (relative to the depressed metallized pattern) then can be subjected to either mechanical, or chemical, or both mechanical and chemical methods to remove the masking-material/metal with reduced impact to the residual antenna pattern. The depressed depth will be very small, perhaps representing 10% to 25% of the total film thickness depending upon any impact to electrical performance of the antenna from the presence of small “upturned flanges” along the edges of the antenna trace.

FIG. 6 is a flowchart showing an alternative method used to manufacture an RFID smart label 200 using patterning processes and release agents in accordance with another embodiment of the present invention. The process begins at step 605 where a substrate is introduced. In this alternative method, formed projections are created in the regions defined by the negative pattern in step 610. Additionally, the surfaces of the substrate to be metallized with a pattern can be slightly depresses with an impress tool to make room for the placement of an RFIC or RFID chip/strap. The temperature of the impress tool can vary. In one embodiment, the temperature of the impress tool is set to be slightly above room temperature so that it is warm. Subsequently, in step 615 the release agent is applied in the desired pattern (corresponding to the impressed area). The release agent, for example, can be a masking material. Next in step 620, a metal layer is vapor deposited over the impressed substrate covering the entire area including the release agent. In step 625 a solvent (e.g. water) is applied over the entire metal layer. Activating the release agent by using a solvent is again not possible as the entire layer of release agent is also covered by the metal deposited layer. By scraping those regions in step 630, which are at a height above that of the metal positive pattern, the metal surface is interrupted and admittance of the solvent to the release agent is provided as described above. The scraping may be done with a solid flat surface that is in contact with the top surface of the structure or with brushes of various kinds (thickness of bristles, flexibility of bristles, etc.). This alternative method can be used either alone or in conjunction with the method described above with reference to FIG. 5. The projections or raised bumps are provided (via a warm pressed tool) in those areas to be covered by the masking material. The bumps are later “scraped” to provide seed points for chemical activity in the release area.

An efficient way of manufacturing RFID tag is to use “roll to roll” processing such as used to print paper. In one embodiment of the present invention, high speed printing technology is used to print finalized facestocks on the RFID smart label 200. The final RFID smart label with facestock includes a label facestock that has been printed using roll-to-roll processing which carries images, colors, and words that describe the item to which the label is attached along with the RFID smart label 200.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process operation or operations, to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

What is claimed is:

1. An RFID smart label, comprising:
a substrate with a depression/recession region;
an RFID antenna deposited over said substrate;
an RFIC located within said depression/recession region and not extending above said RFID antenna so that said RFIC and said RFID antenna form a substantially flat surface for directly printing information or graphics using a roll printer; and
wherein the RFID smart label contains seven layers or less.

2. The RFID smart label of claim 1 further comprising information or graphics that has been directly printed on said RFIC and RFID antenna.

3. The RFID smart label of claim 1 wherein the RFID smart label contains less than seven layers.

4. The RFID smart label of claim 1 wherein said substrate is a roll.

5. The RFID smart label of claim 1 wherein said substrate is a polymer roll.

6. An RFID smart label, comprising:
a release agent used as a release liner for removing other layers;
an adhesive which has low strength to enable removal of said release agent;
a substrate coupled to said adhesive, said substrate having a depression/recession region;
an RFID antenna for receiving or transmitting signals; and
an RFID chip/strap located in said depression/recession region and not extending above said RFID antenna so that said RFID chip/strap and said RFID antenna form a substantially flat surface for directly printing information or graphics using a roll printer.

7. The RFID smart label of claim 6 further comprising information or graphics that has been directly printed on said RFID chip/strap and RFID antenna.

8. The RFID smart label of claim 6 further comprising a passive component so that said RFID smart label does not have internal power.

9. The RFID smart label of claim 6 further comprising an active component and a power source for running said active component.

10. The RFID smart label of claim 6 wherein said release agent is a masking material comprising TiO₂.

11. The RFID smart label of claim 6 wherein said release agent is a masking material comprising about ⅓ TiO₂.

12. The RFID smart label of claim 6 wherein said release agent is a masking material comprising oil.

13. An RFID smart label, comprising:
an RFID inlay having an exterior surface and a depression/recession region located in a substrate;
wherein said RFID inlay is configured to support an RFIC or RFID chip/strap in said depression/recession region to be substantially conformal with said exterior surfaces of said RFID inlay for directly printing on said exterior surfaces of said RFID inlay information or graphics using a roll printer.

14. The RFID smart label of claim 13 further comprising information or graphics that has been directly printed on said exterior surfaces of said RFID inlay.

15. The RFID smart label of claim 13 wherein said depression/recession region has substantially the same depth as the thickness of said RFIC or RFID chip/strap.

16. The RFID smart label of claim 13 wherein said depression/recession region is deeper than the thickness of said RFIC or RFID chip/strap.

17. The RFID smart label of claim 13 wherein said substrate thickness ranges between 2 mils and 5 mils and wherein said RFIC or RFID chip/strap thickness is about 0.8 mils.

18. The RFID smart label of claim 13 wherein said depression/recession region has a depth ranging from between ⅓ and ¼ of the thickness of said substrate.

19. The RFID smart label of claim 13 wherein said depression/recession region is formed gradually by reducing the thickness of a substrate from a first thickness to a second thickness.

20. An RFID smart label, comprising:
a substrate comprising:
a first surface and a depression/recession region in said first surface, wherein said depression/recession region comprises a second surface that is substantially parallel to said first surface;
a third surface connecting said first surface to said second surface, wherein said third surface is not perpendicular to either said first surface or to said second surface; and
an RFIC or RFID chip/strap positioned on said second surface so that said RFIC or RFID chip/strap and said first surface form a substantially flat surface for directly printing information or graphics using a roll printer.

21. The RFID smart label of claim 20 further comprising information or graphics that has been directly printed on said RFIC or RFID chip/strap and said first surface.

22. The RFID smart label of claim 20 wherein said third surface has a length and width that is substantially longer than the length and the width of said second surface.

23. The RFID smart label of claim 20 wherein said length and width of said third surface is 3 to 4 times larger than the length and width of said second surface.

24. The RFID smart label of claim 20 wherein said second surface has a length and a width sufficiently large to hold said RFIC or RFID chip/strap.

25. The RFID smart label of claim 20 wherein said length and width of said third surface is 3 to 4 times larger than the length and width of said RFIC or RFID chip/strap.

26. The RFID smart label of claim 20 wherein said depression/recession region has substantially the same depth as the thickness of said RFIC or RFID chip/strap

27. A method of manufacturing an RFID smart label, comprising:
providing a substrate to support an RFIC or RFID chip/strap;
making a depression in said substrate for positioning said RFIC or RFID chip/strap in said depression; and
positioning said RFIC or RFID chip/strap in said depression so that said RFIC or RFID chip/strap is substantially conformal with an exterior surfaces of said substrate so that said RFIC or said RFID chip/strap and said exterior surface of said substrate form a substantially flat surface for directly printing information or graphics using a roll printer.

28. The method of claim 27 further comprising printing information or graphics directly on said RFIC or RFID chip/strap and said exterior surface of said substrate.

29. The method of claim 27 wherein said step of making a depression is done with debossing.

30. The method of claim 29 wherein said debossing further includes indenting approximately 15% to 35% of the surface of said substrate.

31. The method of claim 27 wherein said step of making a depression is done with thermoforming.

32. A method for manufacturing a radiofrequency identification (RFID) antenna, comprising:
impressing a pattern on a surface of a substrate to make a first portion of the substrate having a positive image of the RFID antenna and a second portion of the substrate having a negative image of the RFID antenna;
applying a release agent on the second portion of the substrate having a negative image of the RFID antenna;
depositing a metallization layer over the surface of the substrate;
applying a solvent over the metallization layer; and
scraping the surface of the substrate causing mechanical interruption of the metallization layer.

33. The method of claim 32 further comprising forming projections in the second portion of the substrate having a negative image of the RFID antenna; said projections are higher then said second portion of the substrate.

34. The method of claim 33 wherein said step of forming projections in the second portion of the substrate further comprises forming bumps that protrude above the second portion of the substrate.

35. The method of claim 32 wherein said step of applying a release agent further comprises applying a masking material comprising TiO₂.

36. The method of claim 32 wherein said step of applying a release agent further comprises applying a masking materials comprising about ⅓ TiO₂.

37. The method of claim 32 wherein said step of applying a release agent further comprises applying a thin coat of a masking material comprising oil.

38. The method of claim 32 wherein said step of depositing a metallization layer further comprises vacuum depositing a metallization layer.

39. The method of claim 32 further comprising the step of applying a facestock using a roll printing process.

40. The method of claim 32 wherein said step of depositing a metallization layer is done using a bi-directional metallization.
